(19) United States
(12) Patent Application Publication
(10) Pub. No.: US 2009/0091648 A1
(43) Pub. Date: Apr. 9, 2009

(54) Multi-resolution Image Sensor Array with High Image Quality Pixel Readout Circuitry

(76) Inventors: Shengmin Lin, Santa Clara, CA (US); Weng-Lyang Wang, Saratoga, CA (US)

Correspondence Address: CHEIN-HWA S. TSAO, 6684 MT PAKRON DRIVE, SAN JOSE, CA, 95120, US

(21) Appl. No.: 11/869,732

(22) Filed: Oct. 9, 2007

(51) Int. Cl. H04N 5/335

(52) U.S. Cl. 348/301

(57) ABSTRACT

A configurable, compact multi-resolution linear image sensor array is disclosed. The multi-resolution image sensor array employs a spatial array of photoelectric sites with each site having an image output terminal and a cluster of switched photo-detector elements. To effect a high quality snapshot operation mode for a high pixel count array, a transfer control switch is added bridging each photo-detector element and its correspondingly connected negative input terminal of an operational amplifier to form an active pixel sensor circuit. To minimize a reset kTC noise associated with numerous traditional active pixel sensor circuits, an in-pixel KTC noise-correlated correlated multiple sampling (CMS) circuitry is also proposed to replace an otherwise traditional correlated double sampling (CDS) circuitry.

### BACKGROUND OF THE INVENTION

1. Field of the Invention

The present invention relates to electronic imaging devices. More specifically, the invention provides an apparatus of configurable resolutions using a small number of photo-detector elements (PE) to form a compact multi-resolution sensor array and for reducing signal noises in an MOS active pixel sensor (APS) circuitry.

2. Description of Related Arts

A multi-resolution linear image sensor array from a prior art typically includes dedicated and separated arrays of photoelectric sensing elements each corresponding to a particular resolution. Hence, such prior art arrays consume relatively large device area with a large number of photo-detector elements (PE) results in relatively low manufacturing yield and high cost. For example, a dual-resolution, 300 dots-per-inch (dpi) and 600 dots-per-inch (dpi), image sensor array includes two dedicated arrays of PE for the two resolutions using 2000 image sensing elements and 1000 image sensing elements respectively. An improved prior art disclosed in U.S. Pat. No. 5,949,483 uses a combined APS array for variable resolutions. While using less number of PE, the prior art of U.S. Pat. No. 5,949,483 requires specially designed row average circuitry, column average circuitry, and temporal average circuitry at the output stage of the APS array for implementing variable resolutions. As a result, this approach is still relatively expensive.

Due to its high device integration density and low power consumption, CMOS APS has gained ground and due to become a dominant imaging technology soon in the market place. However, as of today the major drawbacks of using CMOS APS technology still include significant reset kTC noise (kTCN), significant fixed pattern noise (FPN) and image lag accompanying an array of a large number of PE. As is known in the art, the kTCN is proportional to square root of kT/C where:

k is Boltzmann's Constant=1.38×10⁻²³ J·K⁻¹ and

C is the equivalent capacitance of a PE, for example a photodiode.

Basically, during a reset operation of the CMOS APS circuitry, while all imaging pixels are simultaneously reset a kTCN is generated in the CMOS APS circuitry. An example of the FPN is that, during the fabrication process of the CMOS APS, many device geometric parameters incur a tolerance of around +/−10%, of their respective minimum value under the applicable device technology, resulting in corresponding tolerances of gain and offset of the CMOS transistors of the CMOS APS circuitry.

Numerous prior arts exist for implementing a CMOS APS circuitry. These include circuitries of 3-transistor (3T), 4-transistor (4T), 5-transistor (5T), and so on. The advantages of such circuitries include simplicity of circuitry and relatively high fill factor. Their disadvantages include FPN originated from the so-called source follower used in the circuit and reset noise, i.e. kTCN, originated from resetting the CMOS APS circuitry of the photo-detector array. Another typical prior art circuitry employs a unit gain amplifier (UGA) as its image signal readout structure. The advantages include lower FPN and good linearity but the disadvantages include the presence of reset kTCN. A third typical prior art uses a capacitive trans-impedance amplifier (CTIA) readout structure. The advantages include low FPN, good linearity and controllable gain with disadvantages including the reset kTCN plus it is not suitable for snapshot image capture operation. Yet another prior art adds a circuit for correlated double sampling (CDS) into an APS, where the correlated double sampling (CDS) circuit by itself is known in the art for minimizing reset kTCN. While the CDS circuitry reduces the reset kTCN, it requires dedicated memory elements either on or off a CMOS chip hence resulting in higher cost. As the reset kTCN is correlated following a single reset pulse but uncorrelated between separate reset pulses, the prior art CDS circuitry does not effectively minimize the kTCN. In essence, there exists a need to further improve the current CMOS APS circuitry for controllable gain, good linearity, snapshot image capture operation while simultaneously reducing the FPN and the kTCN with low cost.

### SUMMARY OF THE INVENTION

The present invention discloses a configurable multi-resolution linear image sensor array using only two thirds, i.e., around 2000, of the number of PE used in the first aforementioned prior art predating the U.S. Pat. No. 5,949,483. Yet the present invention does not require as much extra circuitry as the one disclosed in the U.S. Pat. No. 5,949,483 except for adding only one transistor switch between a PE and the input of the readout circuit in an APS thus keeping the cost of the imager low while improving its performance. The present invention amounts to an improved high performance multi-resolution image sensor array using a small number of photo-detector elements and minimal readout circuitry for achieving the multiple resolutions. Furthermore, comparing with the aforementioned prior arts for implementing an APS, the present invention further provides an in-pixel correlated multiple sampling (CMS) circuitry for converting an input photoelectric signal, generated by a switch-resettable photoelectric conversion amplifier in response to an incoming image light pixel, into a corresponding output video signal. The improved APS circuitry thus achieves higher image quality by accommodating snapshot image capture operation while minimizing the FPN and the kTCN with minimal additional circuitry.

### BRIEF DESCRIPTION OF THE DRAWINGS

These and other aspects of the invention will now be described in detail with reference to the accompanying drawings, wherein:

FIG. 1 is a schematic illustrating the architecture of a preferred embodiment of the multi-resolution image sensor array of the present invention;

FIG. 2 is a schematic illustrating one embodiment of an APS circuit with the incorporation of the multi-resolution image sensor array in FIG. 1;

FIG. 3 shows a prior art APS circuit that has a photodiode and three NMOS transistors wherein one of the transistors works as a source follower;

FIG. 4 shows another prior art APS circuit that includes a unit gain amplifier (UGA) for readout;

FIG. 5 shows another prior art APS circuit that adds a CDS readout circuit into the APS of FIG. 4;

FIG. 6 illustrates a timing diagram corresponding to the APS of FIG. 5;

FIG. 7 shows another prior art APS circuit that has a CTIA;

FIG. 8 illustrates the circuit of an improved APS with a CTIA of the present invention;

FIG. 9 illustrates the circuit of a further improved APS with both a CTIA and a CDS of the present invention;

FIG. 10 illustrates a timing diagram corresponding to the APS circuit of the present invention as shown FIG. 9;

FIG. 11 illustrates an alternative APS circuit of the present invention that has a UGA followed by a toggling CDS circuit; and

FIG. 12 illustrates a timing diagram corresponding to the APS circuit of the present invention as shown in FIG. 1.

### DETAILED DESCRIPTION OF THE PREFERRED EMBODIMENTS

The description above and below plus the drawings contained herein merely focus on one or more currently preferred embodiments of the present invention and also describe some exemplary optional features and/or alternative embodiments. The description and drawings are presented for the purpose of illustration and, as such, are not limitations of the present invention. Thus, those of ordinary skill in the art would readily recognize variations, modifications, and alternatives. Such variations, modifications and alternatives should be understood to be also within the scope of the present invention.

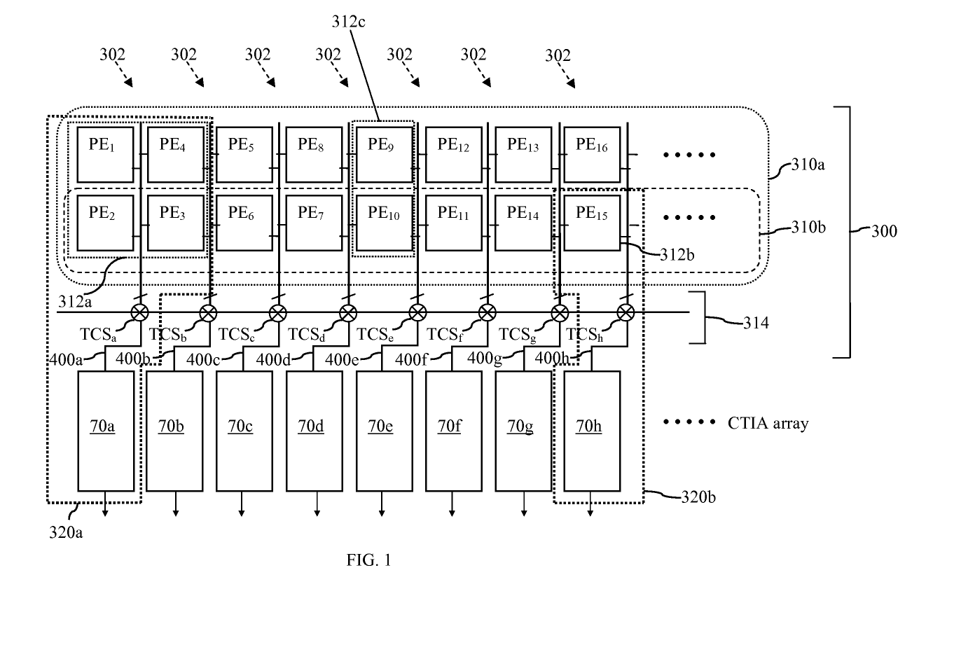

FIG. 1 is a simplified schematic block diagram illustrating the architecture of a preferred embodiment of a multi-resolution image sensor array 300 of the present invention for converting an incoming image light 302 into a corresponding array of image signals 400a, 400b, 400c, 400d, 400e, etc. The multi-resolution image sensor array 300 has a number of photo-detector elements PE₁, PE2, PE3, . . . , PE16, . . . , etc. forming a linear sensor array. For simplicity, each photo-detector element (PE) is illustrated to have a square-shaped photo-detector face (PF) for converting the incoming image light 302 into an elemental detector output signal EDOS and delivering it through its elemental detector output terminal (EDOT), not shown here to avoid unnecessary obscuring details. To those skilled in the art, the PF of each PE can also assume a variety of other pre-determined shapes and sizes for sensing the incoming image light 302 at a corresponding elemental spatial resolution. Each of a cluster of the PEs is switchably connected via a transfer control switch set to selectively combine their photoelectric output signals into a single image signal corresponding to various image sensing resolutions. For example, the photo-detector elements PE₁, PE₂, PE₃ and PE₄ form one cluster that is switchably connected via a transfer control switch set TCSₐ to the image signal 400a. This means that the transfer control switch set TCSₐ actually contains a number of mutually connected switches via which any selected members or all members of the output signals of the photo-detector elements PE₁, PE₂, PE₃ and PE₄ can be electrically connected to form the image signal 400a. For clarity purpose, the replicated array of transfer control switch sets (TCSₐ, TCS_{b}, TCS_{c}, TCS_{d}, . . . , etc.) is named transfer control switch array 314. For another example, the photo-detector elements PE₉, PE₁₀, PE₁₁ and PE₁₂ form another cluster that is switchably connected via a transfer control switch set TCSₑ to the image signal 400e, etc. Thus, expressed in terms of relative image sensing resolution, when all members of the output signals of the photo-detector elements PE₁, PE₂, PE₃ and PE₄ are connected via the transfer control switch set TCSₐ, the resulting image signal 400a corresponds to a 1× resolution with a pixel for 1× resolution 312a. The replication of the pixel for 1× resolution 312a forms a 1× resolution linear PE array 310a. When the members of the output signals of the photo-detector elements PE₉ and PE₁₀ are connected via the transfer control switch set TCSₑ, the resulting image signal 400e corresponds to a 2× resolution with a pixel for 2× resolution 312c. When only the member of the output signal of the photo-detector element PE₁₅ is connected via the transfer control switch set TCSₕ, the resulting image signal 400h corresponds to a 4× resolution with a pixel for 4× resolution 312b. The replication of the pixel for 4× resolution 312b forms a 4× resolution linear PE array 310b. As an example of typical real-world application, 1× can be 300 dots-per-inch (dpi). Then 2× is 600 dpi and 4× is 1200 dpi, etc. Connected to the set of image output terminals for image signals 400a, 400b, 400c, 400d, 400e, etc. are a corresponding set of readout circuits 70a, 70b, 70c, 70d, 70e, etc. for reading the various image signals and converting them into output video signals suitable for further processing. Numerous prior arts exist for implementing the readout circuits, one example as illustrated is an array of capacitive trans-impedance amplifier (CTIA array). In the art, the combination of a PE and its readout circuit is often called an active pixel sensor (APS). Hence, under the present invention, the combination of the PE cluster (PE₁, PE₂, PE₃ and PE₄), the transfer control switch set TCSₐ and the readout circuit 70a constitutes a 1× resolution APS 320a. Likewise, the combination of the PE cluster (PE₁₅), the transfer control switch set TCSₕ and the readout circuit 70h constitutes a 4× resolution APS 320b.

Equivalently, the combination of the cluster of photo-detector elements (PE₁, PE₂, PE₃, PE₄), the transfer control switch set TCSₐ and the image output terminal (IOT) for the image signal 400a forms a first photoelectric site (PES₁). The combination of the cluster of photo-detector elements (PE₅, PE₆, PE₇, PE₈), the transfer control switch set TCS_{c} and the image output terminal (IOT) for the image signal 400c forms a second photoelectric site (PES₂), and so on. The spatial array of PES₁, PES₂, . . . and so on thus forms the multi-resolution image sensor array 300.

By now it should become clear to one skilled in the art that, corresponding to a multitude of combinations of switch closures amongst the transfer control switch array 314 (TCSₐ, TCS_{b}, TCS_{c}, TCS_{d}, . . . ), the multi-resolution image sensor array 300 will convert the incoming image light 302 into an array of image signals at a corresponding multitude of spatial resolutions. The shape of each PE element can be any shape as deemed appropriate for the application, such as rectangle, polygon, circle, ellipse, etc. The size of the PE cluster can be any numbers, certainly not limited to four (4) as illustrated here. With sufficient size of the PE cluster, for example sixteen (16), the multitude of combinations of switch closures amongst each of the transfer control switch set can be further selected within the multi-resolution image sensor array 300 to effect a conversion of the incoming image light 302 into an array of image signals with a corresponding multitude of pixel shapes, such as rectangle, polygon, circle, ellipse, etc. The present invention can be further embodied into a two-dimensional imaging array. As the nature of the present invention multi-resolution image sensor array 300 should be largely independent of the specific device technology for embodying the PE, it can be made of a photoconductor, a photodiode, a photoelectric PIN diode or a high dynamic range photo sensor.

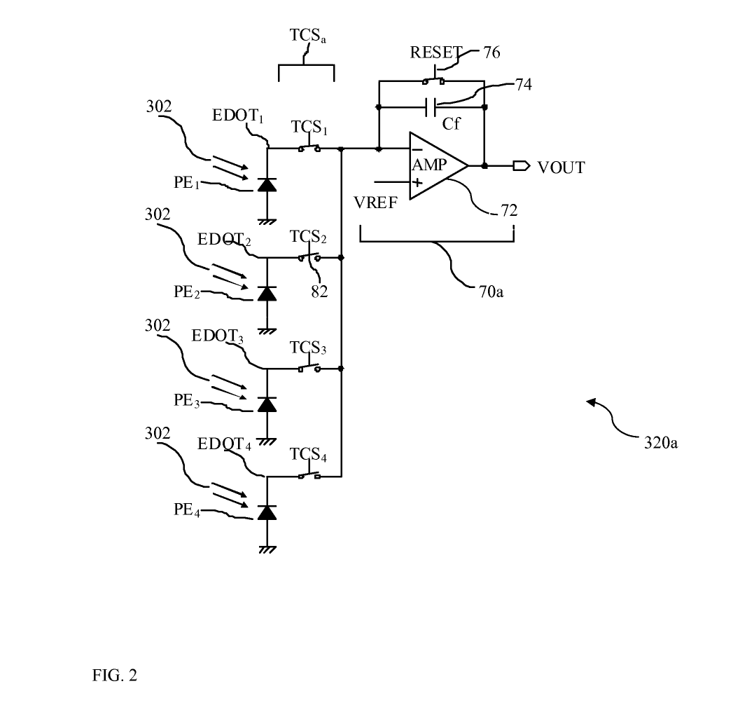

FIG. 2 is a schematic illustrating one embodiment of a 1× resolution APS 320a circuit with the incorporation of a cluster of switched PEs of the multi-resolution image sensor array 300 of FIG. 1. The cluster of PEs (PE₁, PE₂, PE₃, PE₄), each preferably being a CMOS photodiode, are fabricated such that each PE has a grounded anode and is exposed to the incoming image light 302. Thus, each PE accumulates, with its cathode, a charge signal responsive to the incoming image light 302 that in turn gets delivered through its own EDOT. As remarked before, the transfer control switch set TCSₐ includes four individually controllable switches TCS₁, TCS₂, TCS₃ and TCS₄. Each of the controllable switches can be implemented with, for example, a pass transistor. Thus, EDOT₁ is connected to a first end of the switch TCS₁, EDOT₂ is connected to a first end of the switch TCS₂, EDOT₃ is connected to a first end of the switch TCS₃, EDOT₄ is connected to a first end of the switch TCS₄. The second end of the switches TCS₁, TCS₂, TCS₃, TCS₄ are tied together as the negative input of an operational amplifier 72 that is configured, in combination with a charge integration capacitor 74 and a loop-reset switch 76, into a resettable CTIA type of readout circuit 70a. For implementing the 1× resolution, all switches TCS₁, TCS₂, TCS₃ and TCS₄ of TCSₐ are closed simultaneously so as to combine the photoelectric output signals from the four adjacent PEs (each at 4× resolution itself) into a 1× resolution pixel signal by averaging out their accumulated charges delivered respectively through EDOT₁, EDOT₂, EDOT₃ and EDOT₄. Notice that while the transfer control switch set TCSₐ is illustrated to consist of the same number of switches (TCS₁, TCS₂, TCS₃, TCS₄) as the number of PEs, in practice it does not have to be the case. This is specially so when the number of PEs is large and a reduced number of switches are desired for compact device size and low cost. For example, with sixteen (16) PEs spatially arranged in a square matrix, the cathode of each column of PEs can be pre-shorted together to form four (4) first level EDOTs before they go through four (4) second level switches for final connection to the readout circuit 70a. In this case, the transfer control switch set TCSₐ only uses eight (8) switches instead of sixteen (16), etc. It should also become clear by now that the cluster of switched PEs of the multi-resolution image sensor array 300 can be coupled to numerous other types of readout circuit 70a for multi-resolution imaging as well. For example the readout circuit 70a can be of a 3-transistor type or a UGA type as mentioned before.

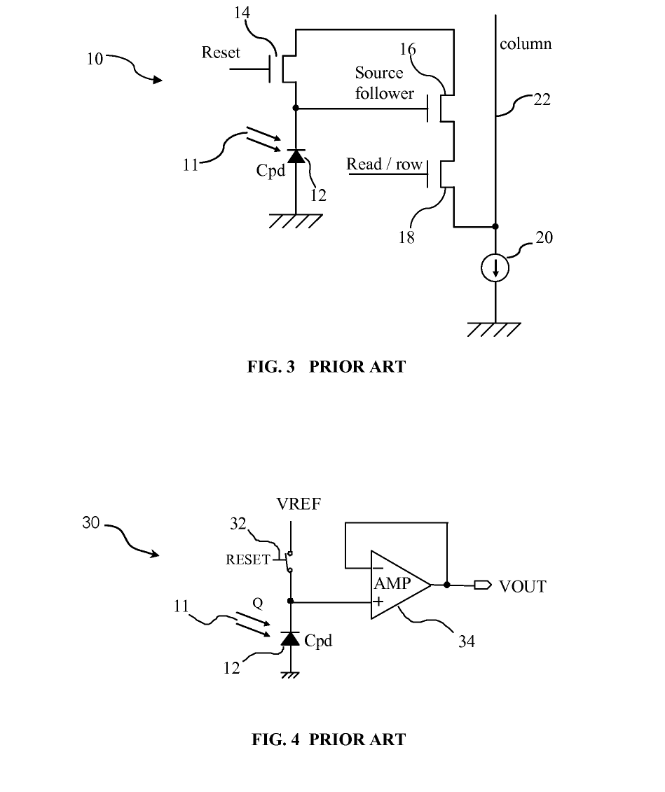

FIG. 3 shows a prior art APS with three transistor readout circuitry 10 that has a photodiode 12 coupled to three NMOS transistors 14, 16 and 18. Upon exposure to an image pixel light 11, the photodiode 12 generates a corresponding photoelectric signal. The second NMOS transistor 16 works as a source follower of the photoelectric signal, the third NMOS transistor 18, in conjunction with a constant current source 20, reads out the photoelectric signal from the photodiode 12 to a column line 22 while the first NMOS transistor 14, upon its turn-on, resets the photodiode 12 for the next photoelectric signal generation and readout. While this prior art circuitry provides simplicity with low cost and high fill factor, it suffers from significant FPN, a voltage gain of less than one and non-linearity of its output signal due to mainly the threshold voltage (Vt) drop of the various NMOS transistors. Most problematically, this prior art circuitry also suffers from significant reset kTCN generated during the turn-on of the first NMOS transistor 14.

FIG. 4 shows another prior art UGA readout APS 30 circuitry that has a photodiode 12 coupled to a UGA 34 for readout. The junction capacitance of the photodiode 12 is denoted by Cpd. Upon exposure to an image pixel light 11, the photodiode 12 generates a corresponding photoelectric signal voltage that gets replicated by the UGA 34 to its VOUT terminal. A reset switch 32, upon its turn-on, resets the photodiode 12 for the next photoelectric signal voltage generation and readout. While, compared to the APS with three transistor readout circuitry 10, the UGA readout APS 30 is relatively free from the problems of FPN, voltage gain of less than one and output non-linearity, this prior art circuitry still suffers from significant reset kTCN generated during the closure of the reset switch 32.

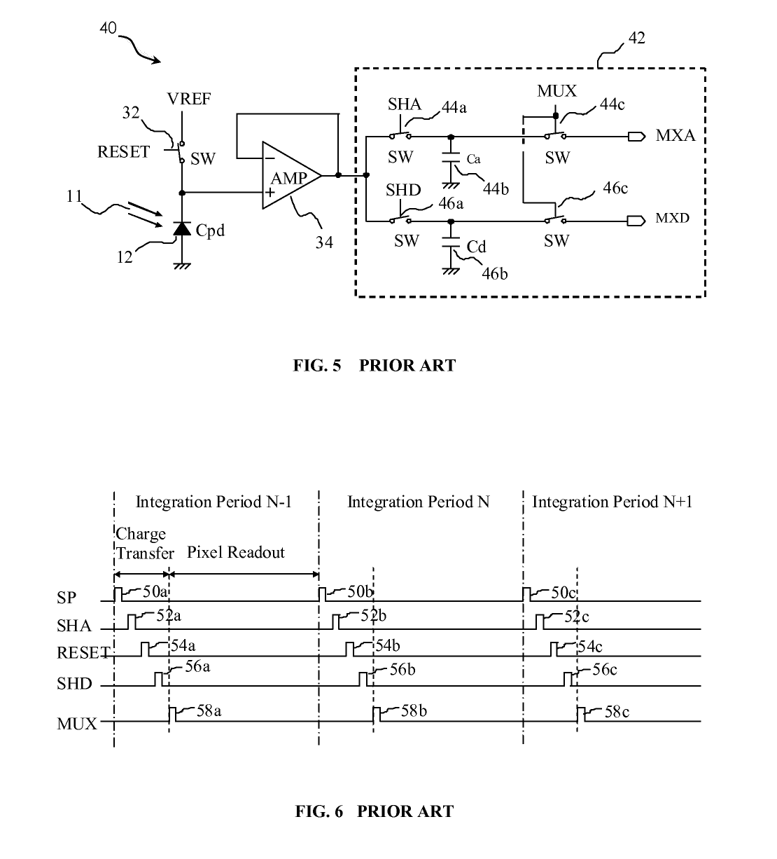

FIG. 5 shows yet another prior art CDS readout APS 40 circuitry that adds a CDS read out circuitry 42 to the UGA readout APS 30 of FIG. 4. The corresponding operation timing diagram of the prior art CDS readout APS 40 circuitry is illustrated in FIG. 6. The intention of the added CDS read out circuitry 42 is, as shown in FIG. 6, to cancel out the effect of the kTCN by subtracting a sampled charge signal on the photodiode 12 (example SHD from 56b) right after a RESET pulse (example 54b) from a sampled charge signal (example 52b) accumulated on the photodiode 12 due to its photoelectric signal generation from exposure to the image pixel light 11 till right before the next RESET pulse (example 54b). Specifically, sampling the charge signal (example 52b) accumulated on the photodiode 12 due to its photoelectric signal generation follows the MXA signal branch with an image multiplexing switch 44a, an image signal storage capacitor 44b and an image multiplexing switch 44c. Whereas, sampling the charge signal on the photodiode 12 (example SHD from 56b) right after a RESET pulse (example 54b) follows the MXD signal branch with a reset multiplexing switch 46a, a reset signal storage capacitor 46b and a reset multiplexing switch 46c. Thus, within a typical Integration Period N, an ordered sequence of logic control signals SP (50b), SHA (52b), RESET (54b), SHD (56b) and MUX (58b) would effect, through the CDS read out circuitry 42, the desired signal sampling and signal subtraction. While the added CDS read out circuitry 42 does provide the advantages of low FPN, good linearity and equivalent dark signal cancellation, it is still ineffective in canceling the reset kTCN. This is so because the sampling of image signal (SHA 52b) and reset signal (SHD 56b) are separated by a RESET signal (RESET 54b). The kTCN content of SHA 52b, following RESET 54a, is generated by the RESET 54a. Whereas the kTCN content of SHD 56b, following RESET 54b, is generated by the RESET 54b. Thus the kTCN content of SHA 52b and the kTCN content of SHD 56b are uncorrelated. To make matters worse, signal subtraction between two statistically uncorrelated noise signals of similar magnitude results in a net noise signal magnitude that is a factor of [square-root of two (2)], about 1.4, of the individual reset kTCN contents.

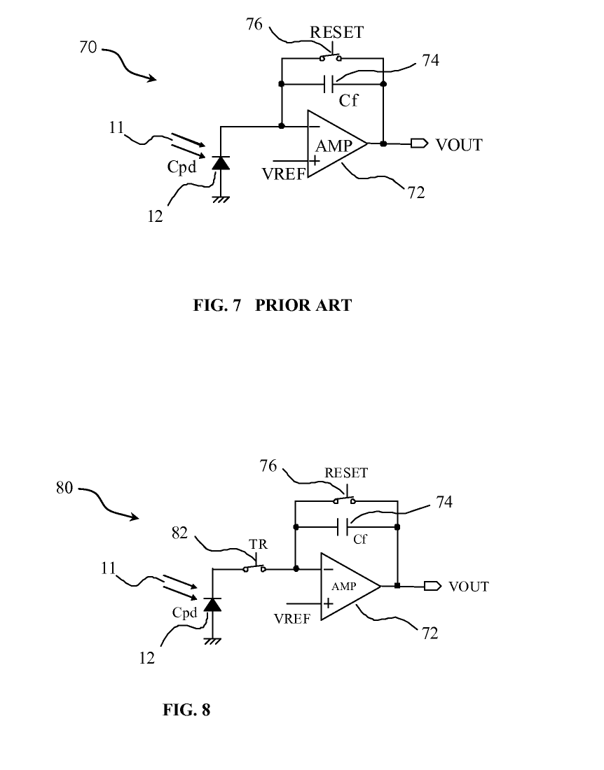

FIG. 7 shows another prior art CTIA readout APS 70 that has a CTIA circuit. The CTIA circuit has an operational amplifier 72 with an output voltage VOUT and with its positive input terminal connected to a reference voltage VREF and its negative input terminal connected to the cathode of the photodiode 12. The feedback branch of the operational amplifier 72 has a parallel connection of a charge integration capacitor Cf 74 and a loop-reset switch 76 for, upon its closure, resetting the accumulated signal charge on the charge integration capacitor Cf 74 after the completion of photoelectric signal readout. The charge-to-voltage conversion rate at VOUT, per unit amount of photoelectric charge Q accumulated at the photodiode 12, is 1/(Cpd+Cf), where Cpd is the equivalent junction capacitance of the photodiode 12. While this prior art readout circuit provides low FPN, good linearity and controllable gain, its drawbacks still include the presence of reset kTCN. Another drawback is an inter-pixel differential charge leakage through the charge integration capacitor Cf 74 causing differential decay, amongst different pixels, of image charge signal with time. For example, the sequential readout of all pixel signals from a linear array imager with a large pixel count, say 5000 pixels, may take 50 ms (milliseconds) at a clock frequency of 100 KHz (kilohertz). The differential decay of image charge signals among different pixels through such a long readout time can become excessive causing significant degradation of a resulting image quality. As is known to those skilled in the art, this problem precludes a “snapshot operation” with the imager.

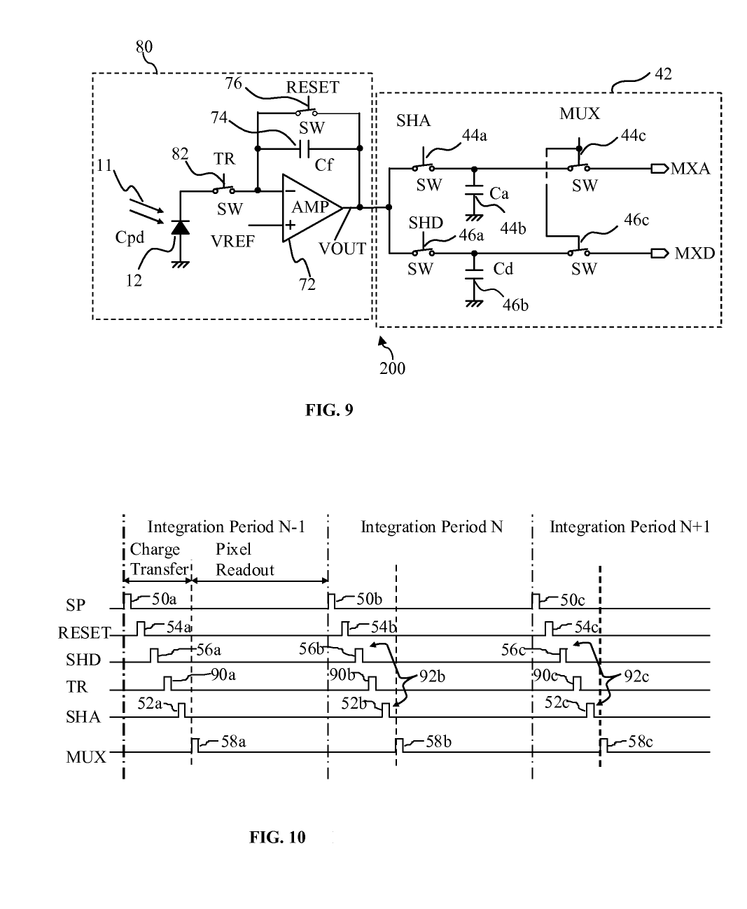

In view of the various aforementioned drawbacks of the numerous prior arts (FIG. 3, FIG. 4, FIG. 5 and FIG. 7), the present invention proposes next two progressively improved APS with a CTIA, called high image quality pixel readout circuitry (HQRC) 80 and high image quality pixel readout circuitry 200, respectively illustrated in FIG. 8 and FIG. 9.

In FIG. 8, a transfer control switch TR 82 is added bridging the cathode of the photodiode 12 and the negative input terminal of the operational amplifier 72. Otherwise, the rest of the HQRC 80 is the same as the CTIA readout APS 70 of FIG. 7. Thus, during a charge accumulation period when the charge signal is being accumulated on the cathode of the photodiode 12, the transfer control switch TR 82 is set open to avoid the aforementioned problem of charge leakage through the charge integration capacitor Cf 74 causing inter-pixel differential decay. However, during a charge transfer period, the transfer control switch TR 82 is set closed to transfer the thus accumulated charge signal into an inbound photoelectric signal at the negative input terminal of the operational amplifier 72 then converted into the outbound photoelectric signal VOUT. In this way, when the HQRC 80 gets replicated into a multi-pixel image sensor array of high pixel count and with sequential image signal readout, the otherwise image-degrading effect of inter-pixel differential leakage of the charge signal through the charge integration capacitor Cf 74 of the operational amplifier 72 can be substantially reduced with proper sequencing of the corresponding array of transfer control switch TR 82. For ongoing time integration of the photoelectric current from the photodiode 12 into the photoelectric voltage VOUT the transfer control switch TR 82 must be closed with the loop-reset switch 76 open. However, to force a complete signal reset of the photodiode 12 and the photoelectric voltage VOUT both of the loop-reset switch 76 and the transfer control switch TR 82 are set closed. In essence, the addition of a properly sequenced transfer control switch TR 82 as described effects a snapshot operation mode. Notice that the FPN and the kTCN are still present in the HQRC 80 thus it warrants further improvement.

The HQRC 200 of FIG. 9 is a further improvement of the present invention HQRC 80 of FIG. 8 with the addition of the CDS read out circuitry 42 of FIG. 5. The signal sequencing of the HQRC 200 are as follows:

1). Resetting the HQRC 80 by momentarily closing the loop-reset switch 76.
2). Transferring a sampled reset signal from VOUT onto the reset signal storage capacitor 46b of the reset sampling branch MXD with a proper setting of the reset multiplexing switch 46a and the reset multiplexing switch 46c.
3). Transferring and converting an accumulated charge signal on the cathode of the photodiode 12 onto VOUT by momentarily closing the transfer control switch TR 82.
4). Transferring a sampled image signal from VOUT onto the image signal storage capacitor 44b of the image sampling branch MXA with a proper setting of the image multiplexing switch 44a and the image multiplexing switch 44c.
5). Obtaining the desired output video signal by calculating the difference between the sampled image signal and the sampled reset signal.
Additionally, the capacitance of image signal storage capacitor 44b and reset signal storage capacitor 46b can be selected to be much bigger than that of photodiode 12 to further minimize the image-degrading effect of inter-pixel differential leakage of the charge signal through the HQRC 80, if any, thus further improving the snapshot operation. In other words, the accumulated image charge signal and the reset charge signal from the photodiode 12 are respectively transferred from the equivalent junction capacitance Cpd of photodiode 12 through charge integration capacitor Cf 74 to two much bigger image signal storage capacitor 44b and reset signal storage capacitor 46b, where the capacitance of image signal storage capacitor 44b and reset signal storage capacitor 46b, if made with a 0.18 micron CMOS fabrication process, is typically of the order of 1 pf (picofarad), being much bigger than that of charge integration capacitor Cf 74 and equivalent junction capacitance Cpd of the photodiode 12 (typically of the order of a few hundred ff (femtofarad)). Storing the image charge signal and the reset charge signal on the relatively bigger capacitors (image signal storage capacitor 44b and reset signal storage capacitor 46b) allows for carrying out a much longer integration period suitable for simultaneous integration of all applicable APS′ in the array hence allowing for a high quality “snapshot” operation without significant inter-pixel differential decay of photoelectric signals due to leakage. In other words, comparing with just using the charge integration capacitor Cf 74, the effect of inter-pixel differential charge leakage is much reduced by using the image signal storage capacitor 44b and the reset signal storage capacitor 46b.

FIG. 10 illustrates a timing diagram of the present invention HQRC 200 circuit of FIG. 9. To simplify the illustration, only three integration periods are shown: Integration Period N−1, Integration Period N and Integration Period N+1. The Integration Period N−1 starts at the rising edge of a logic signal pulse called Start Pulse (SP) 50a and ends at the rising edge of the next SP 50b. The next Integration period N starts at the rising edge of SP 50b. A third Integration Period N+1 starts at the rising edge of SP 50c. Each Integration Period has two portions, a Charge Transfer portion and a Pixel Readout portion, separated by the rising edge of MUX ON signals 58a, 58b and 58c respectively that are also used to control the image multiplexing switch 44c and the reset multiplexing switch 46c. Following SP 50a, 50b and 50c, RESET 54a, 54b and 54c are generated respectively for resetting the charge level of all PEs for each Integration Period N−1, N and N+1. Immediately following RESET 54a, RESET 54b and RESET 54c, sample reset signal SHD 56a, sample reset signal SHD 56b and sample reset signal SHD 56c respectively samples the reset signal at the PE right after reset. The sampled reset signal is stored at reset signal storage capacitor 46b. Next, during sample image signal SHA 52a, sample image signal SHA 52b and sample image signal SHA 52c the integrated image charge signal at the PE are respectively sampled for the Integration Periods N−2, N−1 and N. Notice that, shortly before the sample image signal SHA 52a, a charge transfer period 90a takes place during which time the transfer control switch TR 82 is turned on to transfer the accumulated photoelectric signal at the photodiode 12 to VOUT, etc. More importantly, notice that with the introduction of the transfer control switch TR 82 the kTCN contents of the sample image signal SHA 52b and the sample reset signal SHD 56b come from the same RESET 54b hence they are correlated, marked as kTC-correlated signal pair 92b. Therefore, a later subtraction between 52b and 56b will yield an image signal for the PE with much reduced net kTCN. Likewise, the sample image signal SHA 52c and the sample reset signal SHD 56c form another kTC-correlated signal pair 92c, etc. The sampled image signal is stored at image signal storage capacitor 44b. Afterwards, the MUX ON 58a, MUX ON 58b and MUX ON 58c respectively turns on, for their respective Integration Period, the image multiplexing switch 44c and the reset multiplexing switch 46c to cause a signal transfer from image signal storage capacitor 44b to MXA and from reset signal storage capacitor 46b to MXD. While not shown here to avoid obscuring details, the signals at MXA and MXD are then subtracted to yield a desired image signal for the PE. Hence, the resultant HQRC 200 provides the advantages of snapshot operation, low FPN, low kTCN, good linearity and equivalent dark signal cancellation.

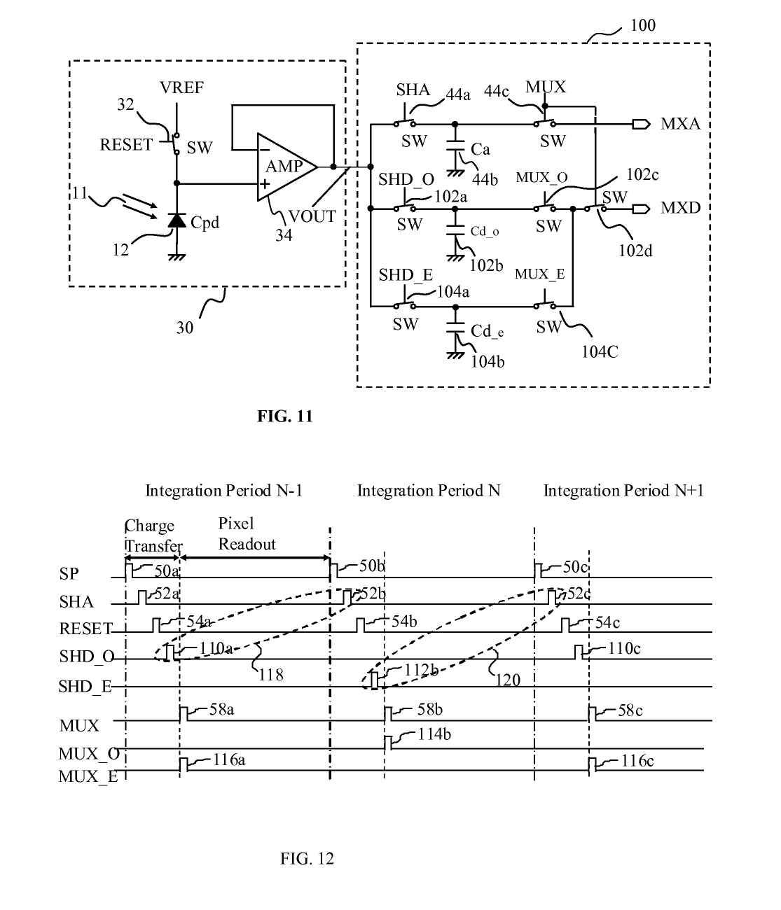

In the absence of the transfer control switch TR 82 as already introduced by the present invention, FIG. 11 illustrates an alternative APS circuit of the present invention that has a UGA readout APS 30 followed by an in-pixel KTC-correlated multiple sampling (CMS) circuitry 100. The operation of UGA readout APS 30 was already described before. The signal branching topology of the in-pixel KTC-correlated CMS circuitry 100 is also similar to that of the CDS read out circuitry 42 already described in FIG. 9 with the exception that the MXD branch of FIG. 9 is further divided into TWO sub-branches end respectively with a reset-odd output multiplexing switch 102c (called the odd branch) and a reset-even output multiplexing switch 104c (called the even branch) before their output signals get multiplexed, via a reset-odd output multiplexing switch 102d, into the same MXD. Otherwise, the front end of the sub-branches has the same structure. That is, the odd branch has a reset-odd sampling multiplexing switch 102a followed by a reset-odd signal storage capacitor 102b. The even branch has a reset-even sampling multiplexing switch 104a followed by a reset-even signal storage capacitor 104b. Similarly, the corresponding timing diagram as illustrated in FIG. 12 is also close to that of FIG. 10 with the following exceptions:
(a) The single signal stream SHD (56a, 56b and 56c) of FIG. 10 get replaced by two separate signal streams SHD_O (110a, 110c) and SHD_E (112b) with their occurrence toggling between odd and even-numbered Integration Periods. That is, sample reset-odd SHD_O 110a takes place within Integration Period N−1, sample reset-even SHD_E 112b takes place within Integration Period N, sample reset-odd SHD_O 110c takes place within Integration Period N+1, etc.
(b) The single signal stream MUX (58a, 58b and 58c) of FIG. 10 also get replaced by two separate signal streams MUX_O (114b) and MUX_E (116a and 116c) with their occurrence toggling between odd and even-numbered Integration Periods. That is, MUX-even ON 116a takes place within Integration Period N−1, MUX-odd ON 114b takes place within Integration Period N, MUX-even ON 116c takes place within Integration Period N+1, etc.
   Thus, as the Integration Periods proceed through odd and even numbered cycles, the corresponding reset signals originated from the photodiode 12 get alternately sampled (switched) into the reset-odd signal storage capacitor 102b and the reset-even signal storage capacitor 104b while the pre-sampled photoelectric image signal on the reset-even signal storage capacitor 104b and on the reset-odd signal storage capacitor 102b get alternately multiplexed onto MUXD. Regardless of the above, the corresponding accumulated image signals from the photodiode 12 always get sampled (switched) into the same image signal storage capacitor 44b. With this scheme and again referring to FIG. 12, the kTCN contents of the sample image signal SHA 52b and the sample reset-odd SHD_O 110a come from the same RESET 54a hence they are correlated, marked as kTC-correlated signal pair 118. Therefore, a later subtraction between 52b and 110a will yield an image signal for the PE with much reduced net kTCN. Likewise, the sample image signal SHA 52c and the sample reset-even SHD_E 112b form another kTC-correlated signal pair 120, etc. Hence, the alternative APS circuit embodiment of FIG. 11 provides the advantages of low FPN, low kTCN, good linearity and equivalent dark signal cancellation. To those skilled in the art, by now it should become clear that the just described scheme employing TWO sub-branches for alternately sampling, storing and outputting the reset signals from the photodiode 12 can be easily extended generally to cases of more than TWO sub-branches while preserving the key advantage of low kTCN.

While the invention has been described in detail by reference to the preferred embodiment described above, it is understood that variations and modifications thereof may be made without departing from the true spirit and scope of the invention. For example, while the present invention is described with numerous embodiments using a linear imager, the present invention can be readily extended to applications of a two-dimensional imager.

What is claimed is:

1. A multi-resolution image sensor array for converting an incoming image light into a corresponding array of image signals, the multi-resolution image sensor array comprises a spatial array of photoelectric sites PESⱼ (j=1, 2, . . . , M with M>=2) for converting the incoming image light into the array of image signals, wherein each PESⱼ further comprises:
a) an image output terminal IOTⱼ; and
b) a cluster of switched photo-detector elements SPEₖ (k=1, 2, . . . , N with N>=2) each having:
b1) a photo-detector element PEₖ, having an elemental detector output terminal EDOTₖ and a photo-detector face PFₖ of pre-determined shape and size for sensing the incoming image light at a corresponding elemental spatial resolution, for converting the incoming image light into an elemental detector output signal EDOSₖ and delivering it through the EDOTₖ; and
b2) a transfer control switch TCS_{K} in series connection with the PEₖ and the IOTⱼ for,
b21) upon switch open, converting the incoming image light into the EDOSₖ with the PEₖ; and,
b22) upon switch closure, transferring the EDOSₖ from the EDOTₖ to the IOTⱼ
whereby, corresponding to a pre-determined multitude of combinations of switch closures amongst the TCS_{K} (k=1, 2, . . . , N), the multi-resolution image sensor array converts the incoming image light into the array of image signals at a corresponding multitude of spatial resolutions.

2. The multi-resolution image sensor array of claim 1 wherein the pre-determined multitude of combinations of switch closures amongst the TCS_{K} (k=1, 2, . . . , N) is further selected such that the multi-resolution image sensor array converts the incoming image light into the array of image signals with a corresponding multitude of pixel shapes.

3. The multi-resolution image sensor array of claim 1 wherein said photo-detector element PEₖ is a photoconductor, a photodiode, a photoelectric PIN diode or a high dynamic range photo sensor.

4. A high image quality pixel readout circuitry for converting an incoming image light pixel into a corresponding output video signal, the high image quality pixel readout circuitry comprises:
a) an operational amplifier having a positive input terminal, a negative input terminal, an output terminal and a feedback loop circuit coupling the output terminal to the negative input terminal, said feedback loop circuit further configured to convert an inbound photoelectric signal at the negative input terminal into an outbound photoelectric signal at the output terminal;
b) a photodiode exposed to the incoming image light pixel, said photodiode having its anode grounded thus accumulating, through its cathode, a charge signal responsive to said incoming image light pixel; and
c) a transfer control switch bridging the photodiode cathode and the negative input terminal, said transfer control switch being:
c1) set open during a charge accumulation period wherein the charge signal gets accumulated on the photodiode cathode; and
c2) set closed during a charge transfer period wherein the thus accumulated charge signal gets transferred into the inbound photoelectric signal at the negative input terminal and converted into the outbound photoelectric signal at the output terminal
whereby, when the high image quality pixel readout circuitry gets replicated into a multi-pixel image sensor array of high pixel count and with sequential video signal readout, an otherwise image-degrading effect of inter-pixel differential leakage of the charge signal through the operational amplifier can be substantially reduced with proper sequencing of the corresponding array of transfer control switches thus effecting a snapshot operation mode.

5. The high image quality pixel readout circuitry of claim 4 wherein said operational amplifier is a resettable capacitive trans-impedance amplifier (CTIA) with the feedback loop circuit further comprises a parallel connection of:
a charge integration capacitor for converting, through time integration, a photoelectric current from the photodiode into a photoelectric voltage at the output terminal; and
a loop-reset switch that:
upon its opening, allows ongoing time integration of the photoelectric current from the photodiode into the photoelectric voltage at the output terminal; whereas
upon its closing forces a complete signal reset of the photodiode and the operational amplifier.

6. The high image quality pixel readout circuitry of claim 5 further comprises an in-pixel correlated double sampling (CDS) circuit having:
an input end being connected to the output terminal of said operational amplifier; and
a following parallel connection of:
a switched image sampling branch having an image signal storage capacitor plus a plurality of image multiplexing switches for providing a sampled image signal corresponding to said photoelectric voltage at the output terminal; and
a switched reset sampling branch having a reset signal storage capacitor plus a plurality of reset multiplexing switches for providing a sampled reset signal corresponding to a reset voltage at the output terminal
whereby allows the desired output video signal to be extracted as the difference between the sampled image signal and the sampled reset signal with an external difference amplifier attached to said in-pixel CDS circuit.

7. The high image quality pixel readout circuitry of claim 6 wherein the signal sequencing of the resettable CTIA and the in-pixel CDS circuit further comprises:
resetting the resettable CTIA by momentarily closing the loop-reset switch;
transferring a sampled reset signal from the output terminal onto the reset signal storage capacitor of the reset sampling branch using a corresponding setting of the plurality of reset multiplexing switches;
transferring and converting the accumulated charge signal on the photodiode cathode into the outbound photoelectric signal at the output terminal by momentarily closing the transfer control switch; and
transferring a sampled image signal from the output terminal onto the image signal storage capacitor of the image sampling branch using a corresponding setting of the plurality of image multiplexing switches
whereby allows the desired output video signal, being the difference between the sampled image signal and the sampled reset signal, to be substantially free of noise distortion by a Reset kTC noise generated with each closure of the loop-reset switch.

8. The high image quality pixel readout circuitry of claim 6 wherein both the image signal storage capacitance and the reset signal storage capacitance are selected to be much bigger than the charge integration capacitance whereby further minimize the image-degrading effect of inter-pixel differential leakage of the charge signal through the operational amplifier thus further improving the snapshot operation mode.

9. An in-pixel correlated multiple sampling (CMS) circuitry for converting an input photoelectric signal, generated by a switch-resettable photoelectric conversion amplifier in response to an incoming image light pixel, into a corresponding output video signal, the in-pixel CMS circuitry comprises a serial connection of:
a) an input end being connected to the input photoelectric signal;
b) a following parallel connection of:
a switched image sampling branch having an image signal storage capacitor and a plurality of image multiplexing switches for providing a sampled image signal corresponding to said input photoelectric signal; and
a plurality of switched reset sampling branches (RSB₁, RSB₂, . . . , RSBⱼ, . . . , RSB_{N}) where N>=2 with each RSBⱼ further comprises:
a reset signal storage capacitor RSCⱼ and a plurality of reset multiplexing switches MSWⱼ for providing a sampled reset signal corresponding to a reset voltage at the output of the switch-resettable photoelectric conversion amplifier upon its reset;
c) a following difference amplifier attached to the parallel connection; and
d) wherein said image multiplexing switches and said reset multiplexing switches MSWⱼ are further sequenced so as to result in a delivery of the following cyclic sequence of signal pairs to the difference amplifier:
(sampled image signal, sampled reset signal from RSB₁), (sampled image signal, sampled reset signal from RSB₂), . . . , (sampled image signal, sampled reset signal from RSBⱼ), . . . , (sampled image signal, sampled reset signal from RSB_{N})
whereby allows the output video signal, being produced by the difference amplifier as the difference between the sampled image signal and the plurality of sampled reset signal from RSBⱼ, to be substantially free of noise distortion by a Reset kTC noise accompanying the reset voltage.

10. The in-pixel CMS circuitry of claim 9 where the switch-resettable photoelectric conversion amplifier is a resettable unity gain amplifier (UGA).

11. The in-pixel CMS circuitry of claim 9 where the switch-resettable photoelectric conversion amplifier is a resettable capacitive trans-impedance amplifier (CTIA).

12. The in-pixel CMS circuitry of claim 11 where the resettable CTIA further comprises a transfer control switch bridging a photodiode cathode and a negative input terminal within the resettable CTIA.

13. The in-pixel CMS circuitry of claim 9 wherein N=2 thus the sequencing of said image multiplexing switches and said reset multiplexing switches MSWⱼ result in a toggled delivery between the following two signal pairs to the difference amplifier:
(sampled image signal, sampled reset signal from RSB₁), (sampled image signal, sampled reset signal from RSB₂).
